(19) United States
(12) Patent Application Publication
(10) Pub. No.: US 2022/0039370 A1
(43) Pub. Date: Feb. 10, 2022

(54) ANIMAL-KILLING APPARATUS

(71) Applicant: CAPTIVIS I/S, Silkeborg (DK)

(72) Inventors: Sune Brøde Holm, Silkeborg (DK); Anders Baadsgaard Schädler Bruun, Silkeborg (DK)

(21) Appl. No.: 17/506,930

(22) Filed: Oct. 21, 2021

Related U.S. Application Data
(63) Continuation of application No. PCT/DK2020/050114, filed on Apr. 24, 2020.

(30) Foreign Application Priority Data
Apr. 24, 2019 (DK) PA 2019 70252

(51) Int. Cl. A01M 23/24

(52) U.S. Cl. CPC A01M 23/24; A01M 2200/00

(57) ABSTRACT

Animal-killing apparatus, which comprises:
a housing,
an entry tunnel, through which an animal can enter said apparatus,
a spring
a spring-actuated striker.

An actuation mechanism, comprising an actuator plate, a connecting lever. Said actuator plate comprises a retention hook through which it is releasably connected to a recess provided in the connecting lever.

Said connecting lever comprises a first connecting lever cam, and the striker comprises a first striker cam, cooperating with said first connecting lever cam for releasably holding the striker in a loaded position.

The animal-killing apparatus comprises an automatic loading mechanism which comprises a motor, said motor is connected to a threaded rod, on which threaded rod there is arranged a displaceable slider comprising a thread engaged with the threaded rod, a sensor device for detection of the position of the striker and the displaceable slider, a power source connected to a controller, which controller receives signals from the sensor device and controls said motor.

### RELATED APPLICATIONS

This application is a continuation of International Application No. PCT/DK2020/050114 which designated the United States and was filed on Apr. 24, 2020, published in English, which claims priority to Denmark Application No. PA 2019 70252, filed on Apr. 24, 2019. The entire teachings of the above applications are incorporated herein by reference.

### FIELD OF THE INVENTION

The present invention relates to an animal-killing apparatus, which comprises:
a housing,
an entry tunnel, through which an animal can enter said apparatus,
a spring
a striker arranged for movement transversal through said entry tunnel upon release of a spring force,
an actuation mechanism, comprising an actuator plate mounted through a pivot in said entry tunnel and a connecting lever mounted through a pivot on a striker housing containing said striker, said actuator plate comprises a retention hook through which it is releasably connected to a recess provided in the connecting lever,
   said connecting lever comprises a first connecting lever cam, and the striker comprises a first striker cam cooperating with said first connecting lever cam for releasably holding the striker in a loaded position.

### BACKGROUND OF THE INVENTION

From the state of the art there are known rat-killing apparatuses which use a striking bar to kill a rat. Those have to be manually loaded by moving the striker bar and connected spring into a loaded position. After actuation, the rat-killing apparatus manually has to be returned to a loaded state.

Furthermore, there are known rat-killing apparatuses which use compressed gas to move a striker. After actuation, those rat-killing apparatuses can automatically return to a loaded state without manual intervention by utilising the compressed gas.

However, those traps have the disadvantage that the force which moves the striker depends on the pressure of the gas. As the pressure in the gas compartment reduces over time and with usage, the force moving the striker reduces accordingly. Thus, the trap might not perform as intended. Animals will not be killed but injured only. Thus, there exists a need for providing an animal-killing apparatus, where the striker always strikes with the same full force.

Additionally, aforementioned rat-killing apparatuses have the disadvantage that the pressurised gas system is not entirely gas tight. Thus, even without being actuated, just standing by idly, the striking force and total number of actuations which the rat-killing apparatus can perform before the pressurised gas compartment has to be changed are reduced. Maintenance has to be performed often in the form of exchanging the pressurised gas compartment. Thus, there exists a need for providing an animal-killing apparatus which can perform a higher number of actuations between maintenance.

An animal-killing apparatus of the type mentioned by way of introduction and as defined in the preamble of claim 1 is known from U.S. Pat. No. 954,996 A. However, this apparatus is not provided with an automatic reset of the striking device.

Moreover, US 2018/271085 A1 discloses an animal-killing apparatus which includes an automatic loading mechanism. However, this document does not disclose a mechanism which may prevent an accidental locking of the actuation mechanism, which would prevent the spring from being tensioned and thus the killing apparatus from being charged.

### OBJECT OF THE INVENTION

It is an object of the invention to provide an animal-killing apparatus which addresses the above-mentioned disadvantages and needs.

It is an object of the invention to provide an animal-killing apparatus in which the striker always actuates with full force.

It is an object of the invention to provide an animal-killing apparatus with prolonged maintenance interval and reduced maintenance effort.

It is an object of the invention to provide an animal-killing apparatus which increases the number of actuations it can perform between maintenances.

It is an object of the invention to provide an animal-killing apparatus which addresses all of the above-mentioned in a single apparatus.

It is an object of the invention to provide a method for operating a killing apparatus.

It is an object of the invention to provide the use of an animal-killing apparatus for killing animals.

### DESCRIPTION OF THE INVENTION

This is achieved with an animal-killing apparatus of the type described in the introduction and the preamble of claim 1, which is peculiar in that the animal-killing apparatus comprises an automatic loading mechanism which comprises a motor, that said motor is connected to a threaded rod, on which threaded rod there is arranged a displaceable slider comprising a thread engaged with the threaded rod, a sensor device for detection of the position of the striker and the displaceable slider, a power source connected to a controller, which controller receives signals from the sensor device and controls said motor. The striker strikes with the spring force. The displaceable slider is arranged for moving the striker and thereby tensioning the spring. The striker comprises a second striker cam which cooperates with the connecting lever.

This is further achieved with a method for operating a killing apparatus, where the method comprises the following steps:
striking an animal entering an entry tunnel with a striker if the animal actuates the actuation mechanism, as a spring exerts a spring force on the striker;
holding the dead animal in place with the striker exerting a force on the dead animal, thereby pressing the animal between the striker and a part of the killing apparatus opposite of the striker, characterised in that the method further comprises the following steps:
activating a moving mechanism comprising an actuator plate mounted through a pivot in said entry tunnel and a connecting lever mounted through a pivot on a striker housing containing said striker, said actuator plate comprises a retention hook through which it is releasably connected to a recess provided in the connecting lever and moving at least the striker and the part of the killing apparatus opposite of the striker, from a first position in which the killing apparatus was ready to kill an animal towards a second position in which the dead animal held by the striker is placed near an opening of a container for collecting animal corpses as the controller of the automatic loading mechanism receives a signals from the sensor device and actives the motor for rotating the threaded rod and thereby displaces the slider which moves the striker;
releasing the dead animal by retracting the striker from the dead animal and thereby placing the dead animal in the container;
reactivating the moving mechanism and moving at least the striker and the part of the killing apparatus opposite of the striker back to the first position as the controller of the automatic loading mechanism receives a signals from the sensor device and actives the motor for rotating the threaded rod and thereby displaces the slider which moves the striker;
bringing the killing apparatus into a loaded position where the actuation mechanism is ready to actuate as the reactivating step ensures a tensioning of the spring acting on the striker as the second striker cam cooperates with the connecting lever.

The spring exerts a spring force on the striker. The spring force propels the striker forward when the actuation mechanism is actuated. Thus the striker is spring-actuated.

The spring is preferably oriented along the direction of motion of the striker. This way the maximum spring force is exerted on the striker. Preferably, the spring is placed adjacent to the striker on the side of the striker facing away from the entry tunnel.

The spring can be oriented along the direction of motion of the striker.

The displaceable slider is arranged for moving the striker and thereby tensioning the spring.

A technical effect achieved with the animal-killing apparatus according to the invention is that the striker always strikes with the same force. The spring force is constant between subsequent actuations of the animal-killing apparatus.

By the striker strikes it is understood that the striker moves into the entry tunnel releasing the spring force. The animal-killing device is intended for small animals, for example rats, mice, other rodents and pigeons.

The animal-killing device can be installed in various locations, for example in and around a building such as a house or in a sewer.

On the roof of a building, for example, it can be used to reduce a pigeon population.

In a sewer or close to a wall of a building it can be used to reduce a rat population.

The killing device can comprise a bait. The bait is preferably placed on a side of the actuator plate facing away from the entry tunnel. The bait can be a substance with an interesting smell for the animal. The bait can be long-lasting. The bait can be permanently installed or replaceable.

An animal entering the entry tunnel has to displace the actuator plate to get to the bait. Displacing the actuator plate activates the actuation mechanism. The retention hook releases the connecting lever. The connecting lever rotates around the pivot in a direction away from the striker housing. The first connecting lever cam is displaced by the rotation of the connecting lever. The first striker cam is released from the first connecting lever cam. The striker is released. The striker moves into the entry tunnel, actuated by the release of the spring force. The striker hits an animal in the entry tunnel killing it in the process.

The actuator plate is pivotally mounted. The connecting lever is pivotally mounted. The actuator plate and the connecting lever functionally work as levers. This reduces an actuation force necessary for actuating the actuation mechanism. Thus an animal entering the entry tunnel only has to apply a small actuation force to the actuator plate to actuate the animal-killing device. An exemplary calculation is shown in the detailed description of the invention.

The animal-killing apparatus does not require a poison.

The power source can be a battery. The battery can be incorporated into the housing. Alternatively, the power source can be external, for example a large capacity battery such as a car battery connected with electrical wires.

The sensor device can comprise different types of sensors, for example mechanical contact sensors or optical sensors.

The actuator plate is mounted pivotally. It is advantageous that the actuator plate and the connecting lever have low friction. Thus, the force for actuating the actuation mechanism is low.

The striker housing can be hexagonal. Alternatively, the striker housing can be a cylinder. The striker housing can be oriented transversal to the entry tunnel.

The animal-killing apparatus can be in a loaded position. By loaded position it is understood that the spring is tensioned. When the spring is in a tensioned position, it is ready to release its spring force, upon release of the striker by the actuation mechanism. The actuation mechanism is also in a loaded position. By that it is understood that the recess and the retention hook are engaged. In the loaded position, the displaceable slider is located at an end position, which end position is adjacent to the entry tunnel. In the loaded position, the animal-killing apparatus is ready to kill an animal upon actuation of the actuation mechanism.

When the actuation mechanism is actuated by rotating the actuator plate around the pivot, the retention hook releases the connecting lever. The spring force from the spring acts on the striker. The first striker cam acts on the first connecting lever cam. The pivot and first connecting lever cam are displaced relative to each other transversal to the direction of movement of the striker. Thus, the force acting on the first connection lever cam leads to a rotation of the connection lever, releasing the striker from the loaded position.

After the striker has struck into the tunnel, the animal-killing apparatus is in a released position. The automatic loading mechanism now brings the animal-killing apparatus into a loaded position. The controller activates the motor. The motor rotates the threaded rod, displacing the displaceable slider towards the spring. The displaceable slider moves the striker opposite the direction of movement of the striker. Thereby the spring is tensioned. When the sensor device signals the controller that the striker is in the loaded position, the controller reverses the direction of the motor. The displaceable slider is moved to the end position. When the displaceable slider reaches the end position, the controller turns off the motor.

The animal-killing apparatus can comprise a contact face for the actuator plate. The contact face keeps the actuator plate from rotating into the entry tunnel.

The threaded rod is substantially parallel to the actuation direction of the striker.

The spring is in a released position when the striker has been released by the actuation mechanism and the striker has moved into the entry tunnel.

The automatic loading mechanism transfers the spring from the released position to the loaded position.

The automatic loading mechanism also transfers the actuation mechanism into a loaded position, where the recess and the retention hook are engaged.

The method can be performed with any embodiment of the killing apparatus described in the present application.

By performing the method, the killing apparatus is cleared of the dead animal and brought back into loaded position ready for killing the next animal without interaction from an operator.

The part of the killing apparatus opposite of the striker can be a part intended specifically to hold the dead animal, such as a bar or bracket. It can also be a part of the entry tunnel. Alternatively, the entire entry tunnel of the trap can be moved together with the striker. Alternatively or additionally, the entire actuation mechanism can be moved together with the striker.

The second striker cam disengages the recess and the retention hook during tensioning of the spring. The connecting lever is rotated about the pivot. Thus, if engaged, the recess and the retention hook disengage.

The technical effect is to prevent an accidental locking of the actuation mechanism, which would prevent the spring from being tensioned and thus the killing apparatus from being charged. By locking of the actuation mechanism it is understood that the recess and the retention hook engage.

In a further embodiment according to the invention, the animal-killing apparatus is peculiar in that the connecting lever comprises a second connecting lever cam. The second connecting lever cam cooperates with the first striker cam to engage the recess and the retention hook. This occurs towards an end of tensioning of said spring.

This locking of the actuation mechanism occurs towards an end of tensioning of said spring.

During tensioning of the spring, when the striker is moved into a loaded position, the first striker cam pushes against the second connecting lever cam. The force exerted on the second connecting lever cam rotates the connecting lever towards the striker housing. The recess and the retention hook are forced into engagement.

The technical effect achieved is that it is ensured that the actuation mechanism is in a ready position, after the spring has been tensioned and the animal-killing apparatus has been charged. The actuation mechanism is forced into the loaded position. Thus, it is avoided that the spring is tensioned, but the actuation mechanism is not ready to trigger the movement of the striker.

In a further embodiment according to the invention, the animal-killing apparatus is peculiar in that the connecting lever and the actuator plate are arranged to provide leverage The leverage reduces an actuation force necessary to actuate the animal-killing apparatus.

The actuation force is applied to the actuator plate. The actuator plate rotates around the pivot with which the actuator plate is mounted. The recess and the retention hook disengage. The animal-killing apparatus is actuated and the striker moves into the entry tunnel.

The technical effect achieved is a reduction in the actuation force which is necessary to actuate the animal-killing apparatus. Thus an animal entering the entry tunnel is more likely to actuate the actuation mechanism of the animal-killing apparatus.

In a further embodiment according to the invention, the animal-killing apparatus is peculiar in that the animal-killing apparatus is arranged for cutting the power to all power-consuming components when the killing apparatus is in a loaded position, in which loaded position the animal-killing apparatus is idle and ready to being actuated.

The animal-killing apparatus can be arranged for cutting the power to the power-consuming components immediately after the killing apparatus reaches the loaded position. This means that the power-cutting is effected within milliseconds.

Alternatively, the animal-killing apparatus can be arranged for cutting the power to the power-drawing components when a predetermined time has lapsed after the loaded position has been reached. This means that the power-cutting is effected within seconds, e.g. after 5 seconds.

The technical effect achieved is that the animal-killing apparatus does not draw power from the power source when it is in a loaded position. In the loaded position, the animal-killing apparatus is idle and ready to being actuated. Thus, the animal-killing apparatus essentially has an unlimited standby time.

The controller can be arranged for cutting the power to power-consuming components. Alternatively, the animal-killing apparatus can cut the power to all power-consuming components.

Alternatively, the sensor device can comprise contact sensors, which mechanical contact sensors cut the power to power-consuming components when the animal-killing apparatus is in a loaded position.

The power to power-consuming components can be cut immediately after reaching the loaded position. Alternatively, the power to the power-consuming components can be cut when a predetermined time has lapsed after the loaded position has been reached.

In a further embodiment according to the invention, the animal-killing apparatus is peculiar in that the sensor device comprises a first sensor, a second sensor and a third sensor, which sensors are arranged at different positions transversal to said entry tunnel.

The first, second and third sensors cooperate with the striker and/or the displaceable slider. The sensors allow control and monitoring of the loading of the animal-killing apparatus. The first sensor is located in a position where it can detect the striker, when the spring is fully tensioned and the first striker cam acting on the second connecting lever cam has engaged the retention hook and the recess.

The second sensor is located closer to the entry tunnel than the first sensor. The second sensor is located in a position where it can detect the striker, when the striker is in a loaded position.

When the striker is in a loaded position and the displaceable slider is in the end position, the animal-killing apparatus is in a loaded position.

The third sensor is located closer to the entry tunnel than the first and second sensor. The third sensor is located adjacent to the entry tunnel. The third sensor is located in a position where it can detect the displaceable slider, when the displaceable slider is located in the end position.

In a further embodiment according to the invention, the animal-killing apparatus is peculiar in that said power source is a battery.

The technical effect achieved is that the animal-killing apparatus is not dependent on an external power source. Thus the animal-killing apparatus can be placed anywhere independent of the available external power sources.

In a further embodiment according to the invention, the animal-killing apparatus is peculiar in that it comprises a display which displays the number of actuations of the animal-killing apparatus.

The technical effect achieved is a longer time interval between maintenances of the animal-killing device. Visual inspection of the display can give an indication if the power source has to be replaced or not. Thus, unnecessary and premature replacement of the power source such as batteries is avoided.

In a further embodiment according to the invention, the animal-killing apparatus is peculiar in that said display only consumes energy when changing the displayed information.

The display will typically be an electronic ink display in order to have a long lifetime for a battery.

The technical effect achieved is lower power consumption of the animal-killing apparatus and thereby an increase in the time between maintenances.

The display can for example be an e-paper or e-ink display or a mechanical teller in order to have a long lifetime for a battery.

In a further embodiment according to the invention, the animal-killing apparatus is peculiar in that said display can display a power source indicator.

In a further embodiment according to the invention, the animal-killing apparatus is peculiar in that said display can display error messages. In a further embodiment according to the invention, the animal-killing apparatus is peculiar in that it comprises an obstruction sensor, which is arranged for detecting obstructions in the entry tunnel.

The obstructions can be killed animals.

The technical effect achieved is a quicker maintenance of the animal-killing apparatus. Visual inspection of the display will indicate if the animal-killing apparatus is operational. It is not necessary to remove the animal-killing apparatus and perform a visual inspection to find out if the entry tunnel is obstructed. Especially, in connection with the embodiment comprising the transmitting unit, maintenance of the animal-killing apparatus is reduced.

In a further embodiment according to the invention, the animal-killing apparatus is peculiar in that it comprises a camera, which is arranged for taking images of the entry tunnel.

In a further embodiment according to the invention, the animal-killing apparatus is peculiar in that it comprises a solar cell.

The solar cell can charge the power source. The technical effect achieved is a prolonged power cycle of the killing apparatus. Thus, the maintenance interval of the killing apparatus is prolonged.

In a further embodiment according to the invention, the animal-killing apparatus is peculiar in that it comprises a transmitting unit.

The transmitting unit can for example be a mobile phone transmitting unit such as a GSM unit, 3G unit, 4G unit or a 5G unit or a WiFi unit.

The animal-killing apparatus can comprise a humidity sensor. The humidity sensor measures an ambient humidity level.

The technical effect is that physical maintenance of the animal-killing apparatus can be drastically reduced. Parts or all of the following information can be transmitted: power source indicator, actuation count, error messages, obstruction sensor status, images from camera, location, serial number, and ambient humidity level.

The transmitting unit can be active or passive. With active is understood a transmitting unit which actively sends such as for example a mobile phone transmitting unit such as a GSM unit, 3G unit, 4G unit or a 5G unit. By passive is understood a unit, which needs an external signal to activate. A passive unit can for example be activated when a maintenance crew in a car is in the vicinity of the animal-killing apparatus. This reduces the time for maintenance, as a visual inspection of the animal-killing apparatus is not necessary for determining its status.

The transmitting unit can be activated by the controller only after the animal-killing apparatus has been actuated. The transmitting unit can be activated for a limited time interval. After the time interval, the controller can cut the power supplied to the transmitting unit. Thus the transmitting unit does only require power when transmitting. No power is consumed in standby. In a further embodiment of the killing apparatus, it comprises a reservoir for liquid bait and a pump for pumping the liquid bait from the reservoir to a baiting position.

The pump for liquid bait has the advantage that an appropriate amount of bait can be ensured in the killing apparatus. The pump can be activated after each striking of the striker to pump liquid bait in the appropriate position. Alternatively, the pump may be activated when the killing apparatus actuation mechanism has not been activated over a predetermined period to replenish the bait.

The reservoir, pump and/or baiting position can be connected with a tube.

In a further embodiment of the killing apparatus, the pump is a peristaltic pump.

Preferably, the peristaltic pump is a linear peristaltic pump.

The peristaltic pump can comprise a flexible tube. The peristaltic pump can comprise a roller. The roller can be mounted on the displaceable slider.

The roller can be mounted in an elongated recess which direction of elongation is at an inclination to the direction of displacement of the displaceable slider.

Thus, when the slider is moving the striker into the loaded position after the killing apparatus has been actuated, the roller is not engaged with the flexible tube.

When the displaceable slider is moved back to the end position after the striker has been brought into the loaded position, on the other hand, the roller engages with the flexible tube and pumps the liquid bait to its intended position in the animal killing apparatus. The liquid bait is pumped from a liquid bait reservoir which is connected to the flexible tube.

Pumping the liquid bait in this way has a number of advantages. The use of a peristaltic pump which is actuated by the motor actuating the movable slide allows the killing apparatus to be constructed without the need for an additional actuator for pumping, which reduces complexity and costs and increases reliability.

Furthermore, since the liquid bait is pumped when the displaceable slider is returning to its end position and is free of the load of the striker and the spring, no additional load is placed on the motor while bringing the striker into the loaded position and thus tensioning the spring.

In a further aspect, the method activating the moving mechanism comprises rotating the striker and at least the part of the killing apparatus opposite of the striker from the first position to the second position.

Using a rotating motion to move from the first position to the second position has the advantage that a mechanically simple and reliable mechanism can be used. This increases reliability of the killing apparatus and reduces the need for maintenance.

The moving mechanism can comprise a rotation axis on which at least the striker and the part of the killing apparatus opposite of the striker are mounted rotationally.

The moving mechanism can comprise a rim and a motor. The motor and the rim can affect the rotational motion.

Preferably, the actuation mechanism, striker housing and entry tunnel are mounted rotationally around the rotation axis.

In a further aspect of the method, activating the moving mechanism comprises rotating the striker and at least the part of the killing apparatus opposite of the striker from the first position to the second position.

The moving mechanism can comprise a first and a second lever, where the first and the second levers are of different lengths. Each lever is at a first end pivotally connected to housing of killing apparatus and at a second end connected pivotally to the striker housing or the entry tunnel.

A further aspect of the invention is the use of a killing apparatus according to any one of the described embodiments for killing animals. The animals can for example be rats or pigeons.

### DESCRIPTION OF THE DRAWING

FIG. 1 shows an embodiment of the animal-killing apparatus according to the invention, a cross-section through the animal-killing apparatus is shown.

FIG. 2 shows the embodiment of the animal-killing apparatus shown in FIG. 1 from a side with the housing and some components removed.

FIG. 3 shows the embodiment of the animal-killing apparatus shown in FIG. 2 from another side.

FIG. 4 shows a cross-section through the embodiment of the animal-killing apparatus shown in FIG. 3.

FIGS. 5-10 show the animal-killing apparatus in different positions between released and loaded positions.

FIG. 11 shows possible installation locations for the animal-killing apparatus.

FIG. 12 shows an embodiment of the animal-killing apparatus where different torque arms are shown.

FIG. 13a shows parts of an embodiment with a peristaltic pump for bait.

FIG. 13b shows an enlargement of a part of FIG. 13a.

FIG. 14a-d shows different positions/timepoints in a method for emptying an embodiment of a killing apparatus.

FIG. 15a-d shows different positions/timepoints in a method for emptying an different embodiment of a killing apparatus.

### DETAILED DESCRIPTION OF THE INVENTION

In the following text the figures will be described one by one, and the different parts and positions seen in the figures will be numbered with the same numbers in the different figures. Not all parts and positions indicated in a specific figure will necessarily be discussed together with that figure.

### LIST OF REFERENCE NUMERALS

1 Animal-killing apparatus

3 Housing

5 Entry tunnel

7 Lower base

9 Ground surface

11 Spring

13 Striker

15 Actuation mechanism

17 Actuator plate

18 Retention hook

19 Pivot, actuator plate

21 Connecting lever

22 Recess

23 Pivot, connecting lever

25 Striker housing

27 First connecting lever cam

29 Second connecting lever cam

31 First striker cam

33 Second striker cam

34 Third striker cam

35 Automatic loading mechanism

37 Motor

39 Threaded rod

41 Displaceable slider

43 Sensor device

45 Power source

47 Controller

49 Direction of movement

51 Gear

53 First sensor

55 Second sensor

57 Third sensor

59 Display

61 Solar cell

63 Obstruction sensor

65 Camera

67 Transmitting unit

69 Contact face

71 Bait

73 First slanted surface

75 Second slanted surface

77 Humidity sensor

79 Building

81 Sewer

83 First connecting lever torque arm

85 Second connecting lever torque arm

87 Actuation point

89 First actuator plate torque arm

91 Second actuator plate torque arm

93 Reservoir

95 Liquid bait

97 Pump

99 Peristaltic pump

101 Flexible tube

103 Roller

105 Elongated recess

107 Animal

109 Part of the killing apparatus opposite of the striker

111 Container

113 Moving mechanism

115 Actuator

117 First lever

119 Second lever

121 Rotation axis

123 Motor, moving mechanism

125 Rim, moving mechanism

Throughout the figures, some components or parts of the animal-killing apparatus 1 have been removed for clarity. For other parts or components, the contours have been made visible on the drawings, even though the components normally would not be visible from this angle as it is covered by another part. Mainly, this applies to the various cams.

FIG. 1 shows an embodiment of the animal-killing apparatus according to the invention. A cross-section through the animal-killing apparatus 1 is shown. For better visibility, parts of the animal-killing apparatus 1 are not shown.

The animal-killing apparatus comprises a housing 3.

The animal-killing apparatus comprises an entry tunnel 5. Animals can enter said apparatus through the entry tunnel 5.

The entry tunnel 5 can be angled at a degree of approximately 45 degrees relative to a lower base 7. When the animal-killing apparatus 1 is placed on a ground surface 9, the angle of 45 degrees allows a killed animal to fall out of the entry tunnel and thus clear the animal-killing apparatus.

The animal-killing apparatus comprises a spring 11. The animal-killing apparatus 1 comprises a spring-actuated displaceable striker 13. The striker 13 is arranged for movement transversal through said entry tunnel upon release of a spring force. The spring force is provided by tensioning the spring 11.

The animal-killing apparatus 1 comprises an actuation mechanism 15. The actuation mechanism 15 comprises an actuator plate 17. The actuator plate 17 is mounted through a pivot 19 in the entry tunnel 5. A connecting lever 21 is mounted through a pivot 23 on a striker housing 25. Parts of the striker housing have been removed for clarity. The striker housing 25 contains the striker 13. More specifically, the striker housing 25 contains the striker 13, when the spring 11 is in a tensioned position. In the tensioned position, the animal-killing apparatus is ready for triggering by the actuation mechanism 15. Upon triggering, the striker 13 strikes into the entry tunnel killing an animal (not shown) located in the entry tunnel 5.

Said actuator plate 17 comprises a retention hook 18. The actuator plate is releasably connected to the connecting lever 21. The retention hook 18 connects releasably to a recess 22 provided in the connecting lever 21 (see also FIG. 3).

The connecting lever 21 comprises a first connecting lever cam 27. The striker 13 comprises a first striker cam 31. The first connecting lever cam 27 and the first striker cam 31 cooperate for releasably holding the striker 13 in a loaded position.

The animal-killing apparatus 1 comprises an automatic loading mechanism 35. The automatic loading mechanism comprises: the spring 11, a motor 37, a threaded rod 39, a displaceable slider 41, a sensor device 43, a power source 45 and a controller 47.

Said motor 37 is connected to the threaded rod 39. On the threaded rod 39 is arranged a displaceable slider 41. The displaceable slider 41 comprises a thread. The thread is engaged with the threaded rod 39. When the motor 37 rotates the threaded rod 39, the displaceable slider 41 is displaced along the threaded rod. The direction of displacement is either in the direction of movement 49 of the striker 13, or opposite the direction of movement 49 of the striker 13. The motor can be connected to the threaded rod with a gear 51.

The power source 45 can be a battery.

The motor can for example be a FK-180SH-10400 motor. This motor operates from 5-500 RPM with a DC voltage between 3 to 24 volts. It includes a high torque gearbox. With 5 volts the motor 37 can tension the spring 11 to a spring force of 140 Newton within 15 seconds.

The sensor device 43 is adapted for detection of the position of the striker 13 and the displaceable slider 41.

The power source 45 is connected to the controller 47. The power source 45 can be a battery. The controller 47 receives signals from the sensor device 43. The controller 47 controls the motor 37 depending on the signals from the sensor device 43.

The animal-killing apparatus 1 comprises a display 59. The display 59 displays the number of actuations of the trap. The display can also display error messages. The display only consumes energy when the displayed information is changed. For example, the display can be an e-paper display. Alternatively, the display can be one or more mechanical tellers.

The animal-killing apparatus 1 comprises an obstruction sensor 63. The obstruction sensor is arranged for detecting obstructions in the entry tunnel 5.

The obstruction sensor 63 can be a camera 65.

The animal-killing apparatus 1 comprises a transmitting unit 67. The transmitting unit can be turned on by the controller 47 for transmitting status information. For example the power source 45 status, the number of actuations, the status of the obstruction sensor 63 or a picture from the camera 65 can be send to an operator. The transmitting unit 67 does not consume energy when deactivated by the controller 47. The power to the transmitting unit 67 can be cut after the transmitting unit 67 has finished transmitting status information.

The transmitting unit 67 can for example be a mobile phone transmitting unit such as a GSM unit, 3G unit, 4G unit, or a 5G unit.

The killing apparatus can comprise a solar cell 61. The solar cell charges the power source 45.

The animal-killing apparatus 1 comprises a bait 71 for attracting animals.

The animal-killing apparatus is arranged for cutting the power to all power-consuming components when the killing apparatus is in a loaded position. In the loaded position it is idle and ready to being actuated.

FIG. 2 shows the embodiment of the animal-killing apparatus shown in FIG. 1 from a side with the housing and some components removed.

The sensor device 43 comprising a first sensor 53, a second sensor 55, and a third sensor 57 is shown.

The sensors are mechanical sensors. Alternatively, other types of sensors, such as for example optical sensors, can be used.

FIG. 3 shows the embodiment of the animal-killing apparatus shown in FIG. 2 from another side. The housing and some components have been removed for clarity.

The actuation mechanism 15 is shown. The retention hook 18 and the recess are engaged 22.

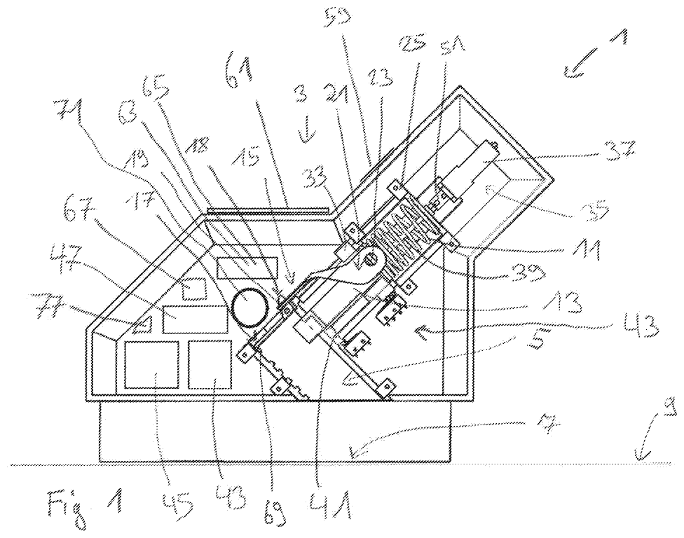

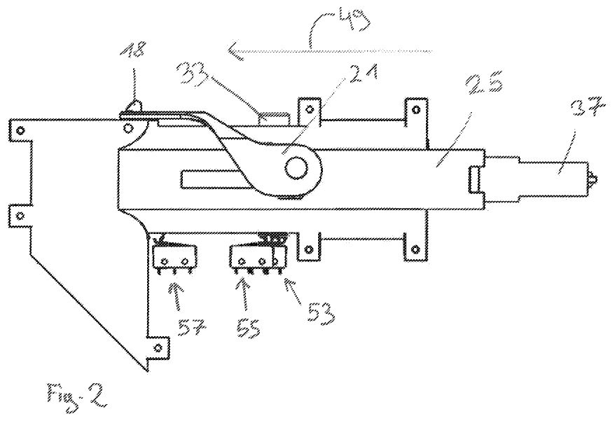

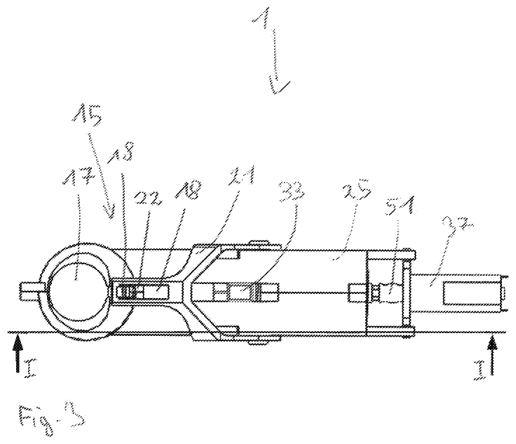

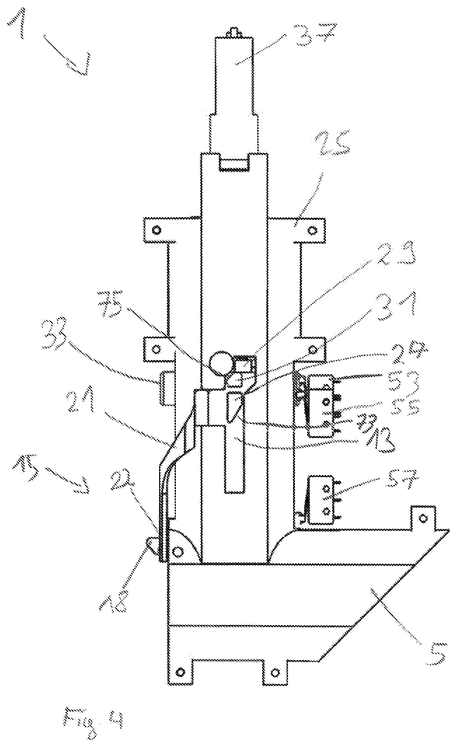

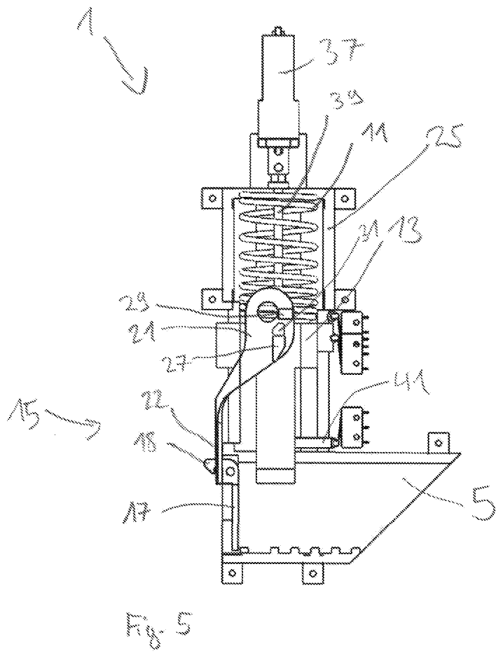

FIG. 4 shows a cross-section through the embodiment of the animal-killing apparatus shown in FIG. 3. The location of the cross-section shown is marked with I in FIG. 3.

The actuation mechanism 15 is in a loaded position. The retention hook 18 on the actuator plate 17 and the recess 22 on the connecting lever 21 are engaged.

The connecting lever 21 comprises a second connecting lever cam 29.

The second connecting lever cam 29 cooperates with the first striker cam 31 to engage the recess 22 and the retention hook 18. This locking of the actuation mechanism 15 occurs towards the end of tensioning of said spring.

During tensioning of the spring, when the striker 13 is moved into a loaded position, the first striker cam 31 pushes against the second connecting lever cam 29. The force exerted on the second con-necting lever cam 29 rotates the connecting lever 21 towards the striker housing 25. The recess 22 and the retention hook 18 are forced into engagement.

The technical effect achieved is that it is ensured that the actuation mechanism is in a ready position, after the spring has been tensioned and the animal-killing apparatus has been charged. Thus, it is avoided that the spring is tensioned, but the actuation mechanism is not ready to trigger the movement of the striker.

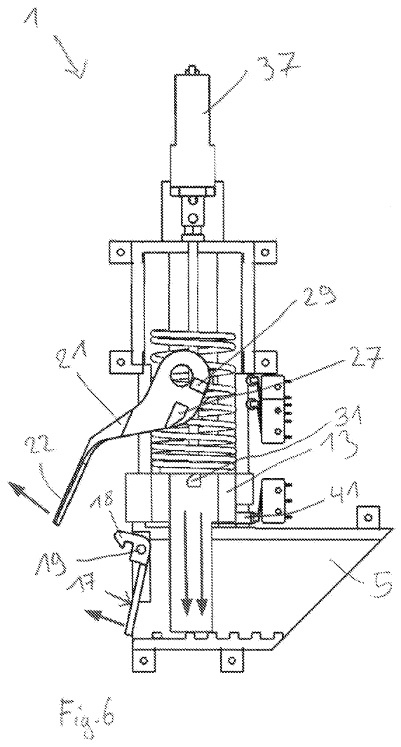

FIGS. 5-10 show the animal-killing apparatus 1 in different positions between released and loaded. The housing and some parts have been removed for clarity.

FIG. 5 shows the animal-killing apparatus 1 in a loaded position. The retention hook 18 and recess 22 are engaged. The spring 11 is tensioned. The striker 13 is inside the striker housing 25 and ready to strike upon actuation of the actuation mechanism 15. The actuator plate 17 covers the entry tunnel. The displaceable slider 41 is in an end position adjacent to the entry tunnel 5. The first connecting lever cam 27 and the first striker cam 31 hold the striker in a loaded position.

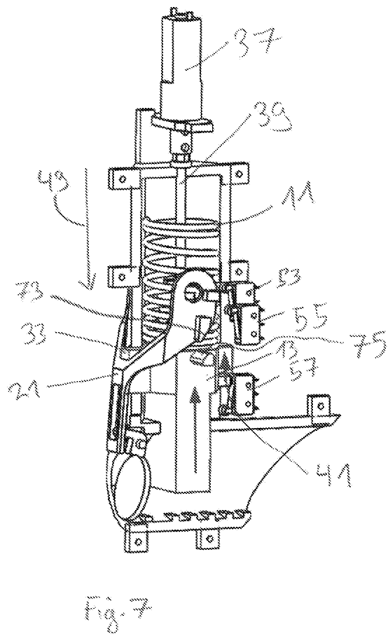

FIG. 6 shows the animal-killing apparatus 1 in a released position after the actuation mechanism 15 has been actuated by applying a force to the actuator plate 17.

The retention hook 18 and the recess 22 have disengaged, caused by a rotating motion of the actuator plate 17 around the pivot 19.

The connecting lever 21 has rotated away from the striker housing 25. The first connecting lever cam 27 releases the first striker cam 31 and the striker has moved into the entry tunnel 5, striking and killing an animal (not shown) inside the tunnel.

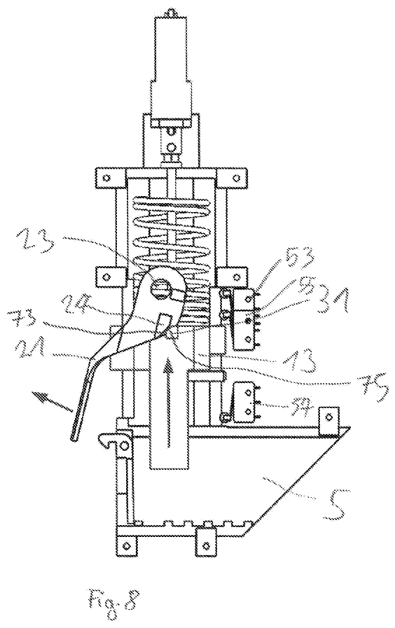

FIG. 7 shows the animal-killing apparatus during the automatic loading. The controller 47 receives a signal that the striker is not in the loaded position by second sensor 55 and activates the motor 37 which rotates the threaded rod 39 and moves the displaceable slider 41 opposite the direction of movement 49 of the striker 13.

The displaceable slider 41 moves the spring-actuated slider 13 opposite the direction of movement 49 of the striker 13. The striker is moved away from the entry tunnel 5 and the spring 11 is tensioned.

The second striker cam 33 blocks the connecting lever 21 from locking the actuation mechanism by engaging the retention hook 18 and the recess 22.

The third sensor 57 does not detect the displaceable slider.

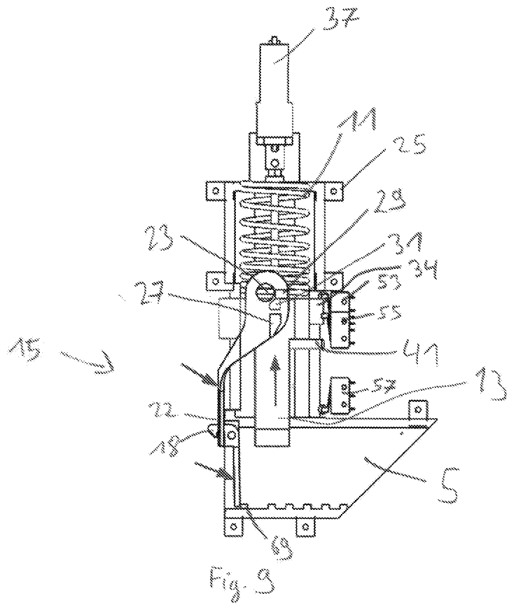

FIG. 8 shows the animal-killing apparatus 1 during a later time point in the automatic loading process. The displaceable slider 41 has moved the striker 13 further away from the entry tunnel 5.

The first striker cam 31 pushes against the first connecting lever cam 27. The connecting lever 21 is rotated around a pivot 23 and away from the striker housing 25.

For this purpose, the first connecting lever cam has a first slanted surface 73 and the first striker cam 31 has a second slanted surface 75.

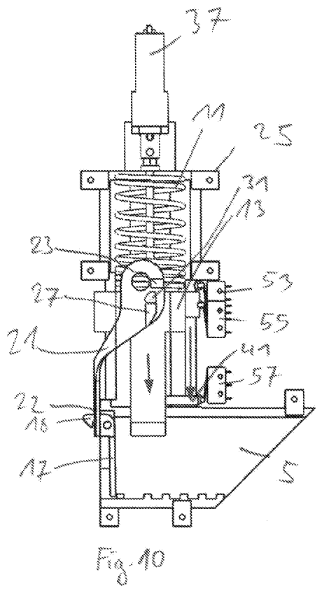

FIG. 9 shows the animal-killing apparatus 1 during a later time point in the automatic loading process than FIG. 8.

When the displaceable slider 41 moves further away from the entry tunnel 5, the first striker cam 31 passes the first connecting lever cam 27.

The first striker cam 31 now pushes against the second connecting lever cam 29. The connecting lever 21 rotates around the pivot 23 and towards the striker housing 25. This rotation forces the actuation mechanism 15 into a loaded position. The hook 18 and the recess 22 engage. The actuator plate 17 engages a contact face 69 in the entry tunnel 5.

The striker 13 comprises a third striker cam 34. The third striker cam interacts with the sensor device 43. More specifically, the third striker cam interacts with the first sensor 53, the second sensor 55 and the third sensor 57.

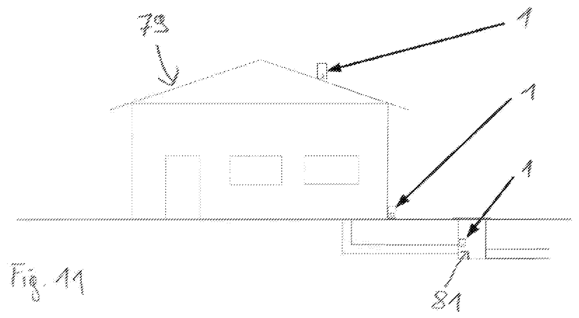

The first sensor 53 signals the controller 47 the location of the striker 13. The controller reverses the direction of the motor 37 and the displaceable slider 41 is moved to the end position adjacent to the entry tunnel 5, as shown in FIG. 10.

The third sensor 57 interacts with the displaceable slider 41 and the motor 37 is stopped.

The animal-killing apparatus 1 is now in a loaded position.

The animal-killing apparatus 1 does not consume any standby power now. This can be achieved by cutting power to all power-consuming components of the animal-killing apparatus 1.

The power to all power-consuming components can be cut when a predetermined time has lapsed after the displaceable slider 41 activates the third sensor 57. The predetermined time interval can be between 5 seconds to 300 seconds, preferably 15 seconds to 120 seconds, more preferably 20 seconds to 60 seconds and most preferably 30 seconds.

Alternatively, the power to all power-consuming components can be cut when the animal-killing apparatus is in a loaded position and the transmitting unit 67 has finished transmitting status information.

When the animal-killing apparatus is actuated and the second sensor 55 does not interact with the striker 13 anymore, power is restored to the power-consuming components.

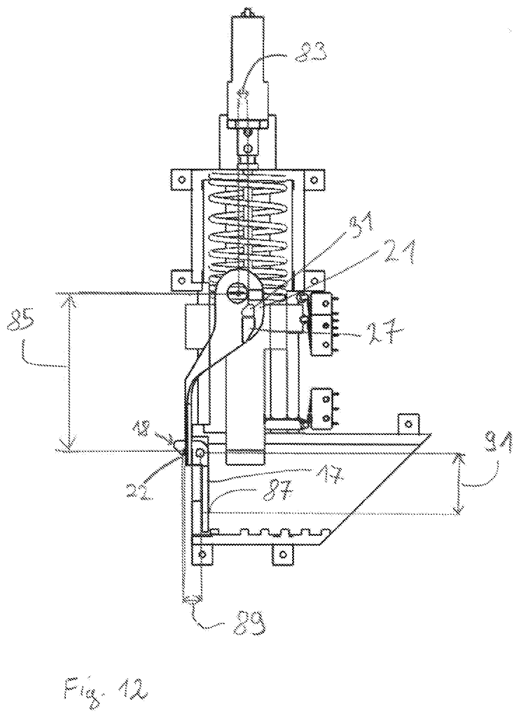

FIG. 11 shows possible installation locations for the animal-killing apparatus 1.

The animal-killing apparatus can for example be placed on the side of a building 79 or in a sewer 81. For example, rat populations can be reduced this way.

Alternatively, the animal-killing apparatus can be installed on the roof of a building. This way, pigeon populations can be reduced.

FIG. 12 shows an embodiment of the animal-killing apparatus 1 with visualisations of different torque arms (83, 85, 89, 91) for approximation of an actuation force.

The connecting lever 21 and the actuator plate 17 are arranged to provide leverage.

The leverage reduces an actuation force necessary to actuate the animal-killing apparatus 1.

In the following exemplary, a minimal actuation force which is necessary to actuate the actuation mechanism is approximated for an embodiment of the animal-killing apparatus 1. The specific values can be adapted by the person skilled in the art to a specific embodiment of the animal-killing apparatus or a specific type of animal targeted.

A spring force of 140 Newton is applied to the first connecting lever cam 27 by the first striker cam 31.

A first connecting lever torque arm 83 has a length of 5.5 mm and a second connecting lever torque arm 85 has a length of 77 mm.

Thus, the connecting lever leverage factor between the spring force applied to the connecting lever 21 and the force the connecting lever 21 applies on the actuator plate 17 is 5.5 mm/77 mm=0.071.

The force the connecting lever 21 applies on the actuator plate 17 is therefore 0,071×140 Newton=10 Newton.

The friction coefficient μ between the retention hook 18 on the actuator plate 17 and the recess 22 on the connecting lever 21 is μ=0.15.

A friction force between the retention hook 18 and the recess 22 is therefore=0.15 μ×10 Newton=1.5 Newton.

This friction force has to be counteracted to disengage the retention hook 18 and the recess 22 and thereby actuating the animal-killing apparatus 1.

It is assumed that an actuation force is applied at an actuation point 87 which is 30 mm from a centre of the pivot 19 of the actuator plate 17.

Then a first actuator plate torque arm 89 with a value of 8 mm and a second actuator plate torque arm 91 with a value of 30 mm generate an actuator plate leverage factor of 8 mm/30 mm=0.267. Thus, the approximate actuation force applied at the actuation point which is necessary to disengage the retention hook 18 and the recess 22 and thereby actuating the animal-killing apparatus is 1.5 Newton×0.267=0.4 Newton.

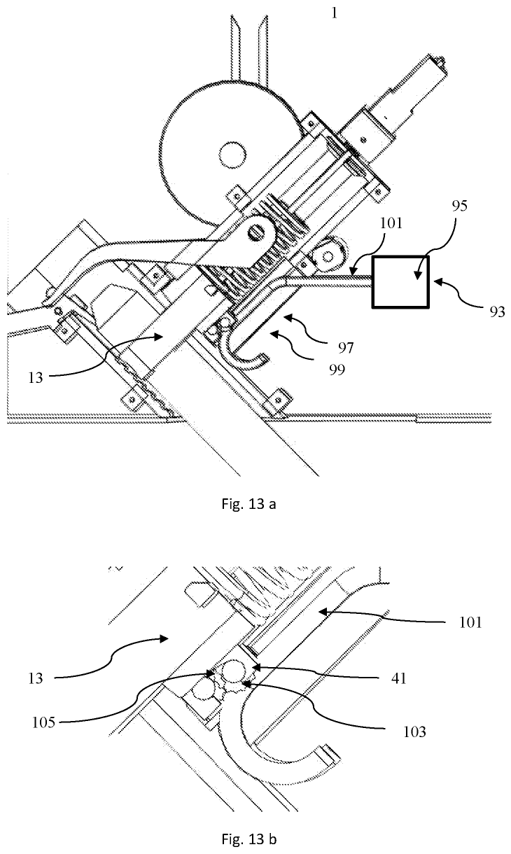

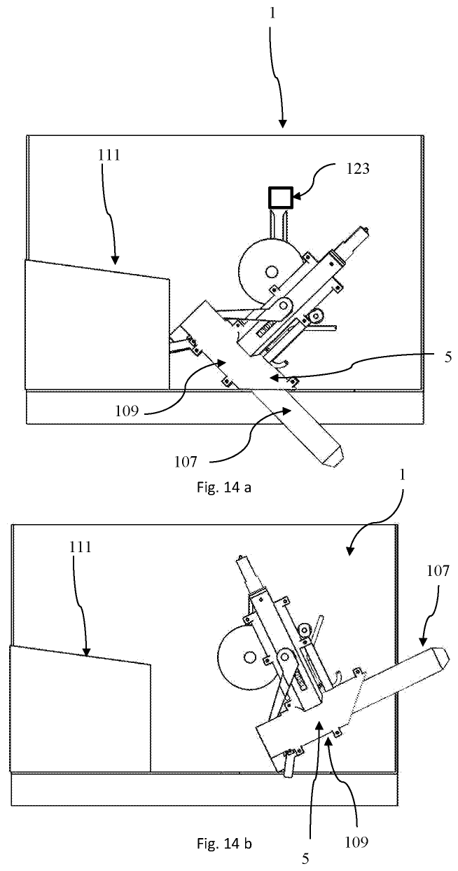

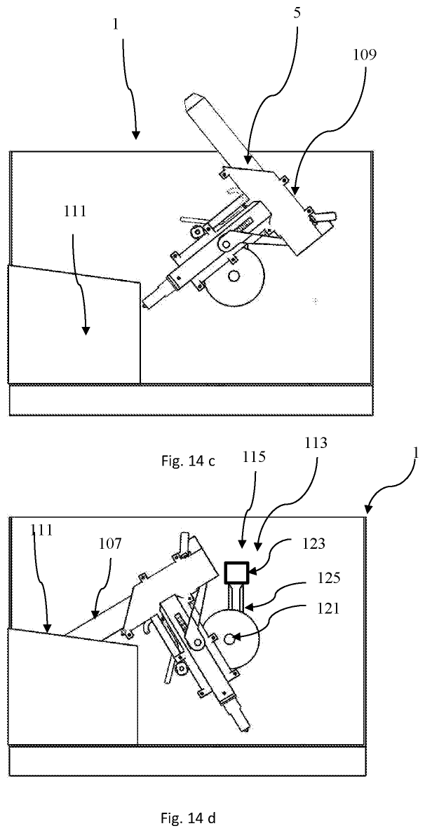

FIG. 13a shows parts of a further embodiment of the killing apparatus 1 which comprises a reservoir 93 for liquid bait 95 and a pump 97 for pumping the liquid bait 95 from the reservoir 93 to a baiting position (not shown).

The pump 97 for liquid bait 95 has the advantage that an appropriate amount of bait 95 can be ensured in the killing apparatus 1. The pump 97 can be activated after each striking of the striker 13 to pump liquid bait in the appropriate position. Alternatively, the pump 97 may be activated when the killing apparatus 1 actuation mechanism 15 has not been activated over a predetermined period to replentish the bait.

The pump 97 is a peristaltic pump 99.

The peristaltic pump 99 is a linear peristaltic pump.

FIG. 13b shows an enlargement of a part of FIG. 13a. The peristaltic pump 99 comprises a flexible tube 101. The peristaltic pump 99 comprises a roller 103. The roller 103 is mounted on the displaceable slider 41.

The roller 103 can be mounted in an elongated recess 105 which direction of elongation is at an inclination to the direction of displacement of the displaceable slider 41.

Thus, when the displaceable slider 41 is moving the striker 13 into the loaded position after the killing apparatus 1 has been actuated the roller 103 is not engaged with the flexible tube 101.

When the displaceable slider 41 is moved back to the end position after the striker 13 has been brought into the loaded position, the roller engages with the flexible tube 101 and pumps the liquid bait to its intended position or baiting position in the animal killing apparatus. The liquid bait 95 is pumped from a reservoir 93 which is connected to the flexible tube 101.

Pumping the liquid bait in this way has a number of advantages. The use of a peristaltic pump which is actuated by the motor actuating the movable slide allows the killing apparatus to be constructed with a single actuator which reduces complexity and costs and increases reliability.

Furthermore, since the liquid bait is pumped when the displaceable slider is returning to its end position and is free of the load of the striker and the spring, no additional load is placed on the motor while bringing the striker into the loaded position and thus tensioning the spring.

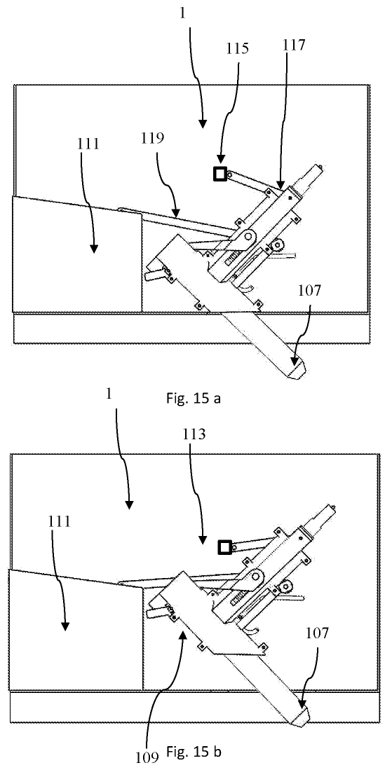

FIG. 14a-d show different positions/timepoints in a method for operating an embodiment of the killing apparatus according to the invention. The method allows automatic transfer of a killed animal to a container without the interaction of an operator.

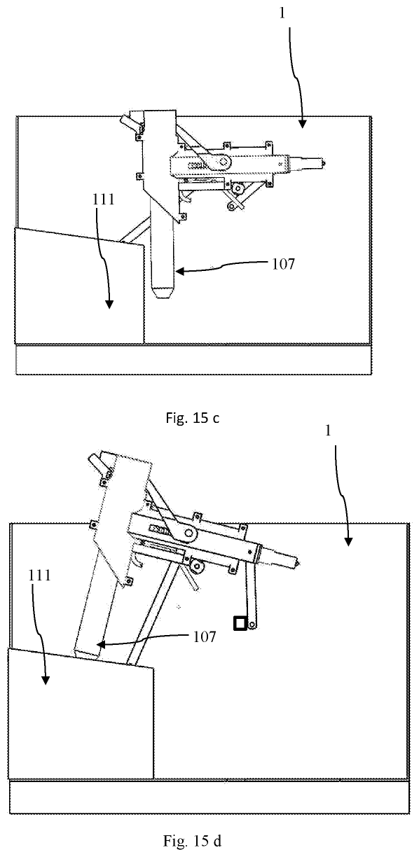

FIG. 15a-d show different positions/timepoints in the method for a different embodiment of the killing apparatus.

The method comprises the following steps:
striking an animal 107 with a striker, if the animal actuates the actuation mechanism (FIG. 14a and FIG. 15a);
holding the dead animal 107 in place with the striker exerting a force on the dead animal, thereby pressing the animal between the striker 13 and a part 109 of the killing apparatus opposite of the striker, (FIG. 14a and FIG. 15a);
activating a moving mechanism 113 comprising an actuator 115 and moving at least the striker and the part 109 of the killing apparatus opposite of the striker, from a first position (FIG. 14a and FIG. 15a) in which the killing apparatus was ready to kill an animal towards a second position (FIG. 14d and FIG. 15d) in which the dead animal held by the striker is placed near an opening of a container 111 for collecting animal corpses;
releasing the dead animal by retracting the striker 13 from the dead animal 107 and thereby placing the dead animal 107 in the container 111, (FIG. 14d and FIG. 15d);
reactivate the moving mechanism 113 and moving at least the striker 13 and the part of the killing apparatus 1 opposite of the striker back to the first position; and
bringing the killing apparatus 1 into a loaded position where the actuation mechanism 15 is ready to actuate.

FIG. 14a and FIG. 15a show the killing apparatus in the first position. FIG. 14d and FIG. 15d show the killing apparatus in the second position. FIG. 14b /15b and FIG. 14c and FIG. 15c show intermediate positions.

The method can be performed with any embodiment of the killing apparatus described in the present application.

In the method shown in FIG. 14a-d, activating the moving mechanism comprises rotating the striker 13 and at least the part of the killing apparatus 109 opposite of the striker from the first position to the second position.

The moving mechanism 113 comprises a rotation axis 121 on which at least the striker and the part of the killing apparatus opposite of the striker are mounted rotationally.

The moving mechanism can comprise a rim and a motor. The motor and the rim can affect the rotational motion.

Preferably, the actuation mechanism, striker housing and entry tunnel are mounted rotationally around the rotation axis.

By performing the method, the killing apparatus is cleared of dead animal and brought back into loaded position ready for killing the next animal without interaction from an operator.

In the method shown in FIG. 15a-d, activating the moving mechanism 113 comprises rotating the striker 13 and at least the part 109 of the killing apparatus opposite of the striker from the first position to the second position. The moving mechanism can comprise a first 117 and a second lever 119, where the first 117 and the second levers 119 are of different lengths. Each lever 117, 119 is at a first end pivotally connected to a housing of killing apparatus and at a second end connected pivotally to the striker housing or the entry tunnel.

The part of the killing apparatus opposite of the striker can be a part intended specifically to hold the dead animal, such as a bar or bracket. It can also be a part of the entry tunnel. In the two embodiments shown in FIG. 14 and FIG. 15, the entry tunnel of the trap can be moved together with the striker and the entire actuation mechanism.

Using a rotating motion to move from the first position to the second position has the advantage that a mechanically simple and reliable mechanism can be used. This increases reliability of the killing apparatus and reduces the need for maintenance.

FIG. 15 shows an embodiment, where the motion from the first to the second position is provided by two levers 117, 119 of different length both mounted pivotally on the housing of the killing apparatus and on the striker housing.

1. Animal-killing apparatus, which comprises:
a housing,
an entry tunnel, through which an animal can enter said apparatus,
a spring, exerting its spring force on
a striker arranged for movement transversal through said entry tunnel upon release of a spring force,
an actuation mechanism, comprising an actuator plate mounted through a pivot in said entry tunnel and a connecting lever mounted through a pivot on a striker housing containing said striker, said actuator plate comprises a retention hook through which it is releasably connected to a recess provided in the connecting lever,
said connecting lever comprises a first connecting lever cam, and the striker comprises a first striker cam cooperating with said first connecting lever cam for releasably holding the striker in a loaded position, wherein the animal-killing apparatus comprises an automatic loading mechanism which comprises a motor, wherein said motor is connected to a threaded rod, on which threaded rod there is arranged a displaceable slider comprising a thread engaged with the threaded rod, a sensor device for detection of the position of the striker and the displaceable slider, a power source connected to a controller, which controller receives signals from the sensor device and controls said motor, wherein the striker strikes with the spring force, wherein the displaceable slider is arranged for moving the striker and thereby tensioning the spring and wherein the striker comprises a second striker cam which cooperates with the connecting lever.

2. Animal-killing apparatus according to claim 1, wherein the connecting lever comprises a second connecting lever cam, which second connecting lever cam cooperates with the first striker cam to engage the recess and the retention hook towards an end of tensioning of said spring.

3. Animal-killing apparatus according to claim 1 or 2, wherein the connecting lever and the actuator plate are arranged to provide leverage, which leverage reduces an actuation force necessary to actuate the animal-killing apparatus.

4. Animal-killing apparatus according to claim 1 or 2, wherein the animal-killing apparatus is arranged for cutting the power to all power-consuming components when the killing apparatus is in a loaded position, in which loaded position it is idle and ready to being actuated, wherein the power-cutting is effected immediately after the killing apparatus reaches the loaded position or when a predetermined time has lapsed after the loaded position has been reached.

5. Killing apparatus according to claim 1 or 2, wherein the sensor device comprises a first sensor, a second sensor and a third sensor, which sensors are arranged at different positions transversal to said entry tunnel.

6. Killing apparatus according to claim 1 or 2, wherein said power source is a battery.

7. Killing apparatus according to claim 1 or 2, wherein it comprises a display which displays the number of activations of the trap, and that said display only consumes energy when changing the displayed information.

8. Killing apparatus according to claim 1 or 2, wherein it comprises an obstruction sensor, which is arranged for detecting obstructions in the entry tunnel.

9. Killing apparatus according to claim 1 or 2, wherein it comprises a transmitting unit, which transmitting unit can transmit status information of the animal-killing apparatus.

10. Killing apparatus according to claim 1 or 2, wherein it comprises a reservoir for liquid bait and a pump for pumping the liquid bait from the reservoir to a baiting position.

11. Killing apparatus according to claim 10, wherein the pump is a peristaltic pump.

12. Method for operating a killing apparatus according to any of the claims 1-11, where the method comprises the following steps:
striking an animal entering an entry tunnel with a striker if the animal actuates the actuation mechanism, as a spring exerts a spring force on the striker
holding the dead animal in place with the striker exerting a force on the dead animal, thereby pressing the animal between the striker and a part of the killing apparatus opposite of the striker,
wherein the method further comprises the following steps:
activating a moving mechanism comprising an actuator plate mounted through a pivot in said entry tunnel and a connecting lever mounted through a pivot on a striker housing containing said striker, said actuator plate comprises a retention hook through which it is releasably connected to a recess provided in the connecting lever and moving at least the striker and the part of the killing apparatus opposite of the striker, from a first position in which the killing apparatus was ready to kill an animal towards a second position in which the dead animal held by the striker is placed near an opening of a container for collecting animal corpses as the controller of the automatic loading mechanism receives a signals from the sensor device and actives the motor for rotating the threaded rod and thereby displaces the slider which moves the striker,
releasing the dead animal by retracting the striker from the dead animal and thereby placing the dead animal in the container,
reactivating the moving mechanism and moving at least the striker and the part of the killing apparatus opposite of the striker back to the first position as the controller of the automatic loading mechanism receives a signals from the sensor device and actives the motor for rotating the threaded rod and thereby displaces the slider which moves the striker,
bringing the killing apparatus into a loaded position where the actuation mechanism is ready to actuate as the reactivating step ensures a tensioning of the spring acting on the striker as the second striker cam cooperates with the connecting lever.

13. Method according to claim 12, where activating the moving mechanism comprises rotating the striker and at least the part of the killing apparatus opposite of the striker from the first position to the second position.

14. Method according to claim 12 where the method of activating the moving mechanism comprises rotating the striker and at least the part of the killing apparatus opposite of the striker from the first position to the second position.

15. Use of a killing apparatus according to any one of the claims 1-11 for killing animals, preferably rats.
